(19) United States
(12) Patent Application Publication
(10) Pub. No.: US 2025/0250998 A1
(43) Pub. Date: Aug. 7, 2025

(54) MOBILE ACCESS CONTROL GANG CLAMP

(71) Applicant: Rizon Manufacturing, Inc., Clarksville, IN (US)

(72) Inventors: Eric Mager, Louisville, KY (US); James Kelly, Louisville, KY (US); John Mager, Indianapolis, IN (US)

(21) Appl. No.: 18/435,000

(22) Filed: Feb. 7, 2024

(51) Int. Cl. F16B 2/06

(52) U.S. Cl. CPC F16B 2/065

(57) ABSTRACT

A gang clamp assembly for securely coupling a mobile access control device to an adjacent mobile access control device. The clamp assembly includes a first bracket and a second bracket. Each bracket includes a first leg and a second leg separated by an offset. Each bracket is configured to envelop a portion of the exterior surfaces of structural members of the mobile access control devices, such that the offset provides an additional surface against which the structural members can bear. Each bracket includes a first fastener receiving opening in the first leg and a second fastener receiving opening in the second leg. A first fastener is insertable into the first fastener receiving opening in the first leg of the first bracket and the second fastener receiving opening in the second leg of the second bracket.

### TECHNICAL FIELD

The present disclosure generally relates to mobile physical access control units, such as turnstiles.

### BACKGROUND

Access control is an issue important to many types of businesses, buildings, venues, government agencies, construction sites, and various other locations. In its most general sense, access control can be understood as any system, apparatus, or method to facilitate the desired manner, type, characteristic, and number of persons that enter or leave a controlled area, generally from an uncontrolled area. That is, in general, access control devices control (in any of a number of manners) access from an uncontrolled area to a controlled area. Controlling access is important for many reasons, including but not limited to, ensuring that only authorized persons are allowed into the secured location; providing a barrier for unauthorized persons; ensuring a safe and orderly flow of traffic through the access control device; facilitating the counting and/or identities of persons passing through the device; preventing multiple persons passing through in a single activation; and many other reasons.

Many types of access control systems exist, and the various types often depend on the application for which they were designed. Non-limiting examples of some common types of access control devices include various types of turnstiles (e.g., waist-high turnstiles, “tripod” turnstiles, full-height turnstiles, optical turnstiles, revolving-door turnstiles), full-height gates, non-full-height gates, security doors, and other forms of physical barriers that can selectively allow and prevent access therethrough. Such access control devices are designed and manufactured for the particular type of building/venue/environment/use needs at issue. As such, access control devices can be designed for permanent installation indoors (e.g., at the entrance to a particular area or room of a building) or outdoors (e.g., at a perimeter of a venue, such as a football stadium). Also, depending on the particular needs of the owner, such access control devices can be employed as a single unit, or as multiple separate units, or as multiple connected units.

As mentioned, the ultimate needs for the access control device will impact the design, manufacture, installation, and use of the access control device. A single access control device placed inside the lobby of an office building, for example, does not need to be made weatherproof, can be designed for permanent installation (e.g., to the floor of the lobby), need not have a roof or other canopy, and may or may not need to be connected to any type of perimeter fencing. On the other hand, access control devices for outdoor usage requires either weatherproof components or enclosures/coverings (or both), and often is required to be connected to some form of perimeter enclosure (e.g., fence).

Particular problems can arise in certain types of outdoor applications. Construction sites, for example, pose challenges not encountered in the vast majority of applications of typical access control devices. Construction sites are often very large and often require the entry/exit of large numbers of persons in a short amount of time. As such, it is often desirable to provide multiple access control devices at any given access point, so that more people can enter the site in a given time than if only a single access control device were used. In addition, construction sites often do not have nicely paved areas for placing such access control devices (let alone the very stable and smooth floors that are present in the majority of indoor applications discussed above). In fact, in most construction site applications, the access control devices are necessarily placed on various ground surfaces that are uneven, unstable, and in many cases, shifting. For example, often the access control devices must be placed directly on dirt, mud, gravel, hillsides, and other uneven and unstable materials. This poses many challenges for the placement and use of the mobile access device. And, when multiple access control devices are needed (e.g., sites requiring the passage of large numbers of persons in a given time period), it is typically desired that the multiple access control devices be placed adjacent each other, so that entry/exit to/from the construction site occurs at the same location. However, the placement of the mobile access control devices on the uneven and unstable ground causes even more problems. The mobile bases (typically rectangular metal plates) of each access control device rely for support on the ground on which they are placed. When the ground shifts or moves (as when dirt turns to mud, or when the gravel moves), the access control device moves with it. This relative movement between adjacent access control devices creates many safety problems, including instability of the devices, tipping hazards, possible separation of the devices that could allow unauthorized entry, significant pinch points, and so forth.

### SUMMARY

In the embodiments described herein, a solution is provided to the various problems encountered in the use of multiple adjacent access control devices situated on uneven or unstable ground.

In one embodiment, a gang clamp assembly for access control devices is provided that comprises a first bracket having a first leg and a second leg separated from the first leg by a first offset, wherein the first leg has an outer surface and an inner surface and the second leg also has an outer surface and an inner surface. Similarly, a second bracket is provided that has a first leg and a second leg separated from the first leg by a second offset, wherein the first leg has an outer surface and an inner surface and the second leg has an outer surface and an inner surface. The first bracket has a first fastener opening in the first leg of the first bracket and a second fastener opening in the second leg of the first bracket. Similarly, the second bracket has a first fastener opening in the first leg of the second bracket and a second fastener opening in the second leg of the second bracket. When assembled for use, a first fastener extends through the first fastener opening of the first leg of the first bracket and through the second fastener opening of the second leg of the second bracket; and a second fastener extends through the first fastener opening of the first leg of the second bracket and through the second fastener opening of the second leg of the first bracket.

In another aspect, a gang clamp assembly for securing adjacent access control devices is provided comprising a first bracket having a first portion with a first fastener opening at a first end of the first portion, and a second portion with a second fastener opening at a second end of the second portion. The first bracket has a first offset separating the first portion from the second portion, the first portion being parallel to the second portion and. Similarly, the second bracket has a first portion with a third fastener opening at a first end of the first portion, and a second portion with a fourth fastener opening at a second end of the second portion. The second bracket has a first offset separating the first portion from the second portion, with the first portion being parallel to the second portion. The first bracket and the second bracket are configured to envelop, encircle, surround, or otherwise be disposed about various surfaces of the one or more structural members of the two adjacent access control devices such that the one or more structural members engage a surface of the first portion of the first bracket, a surface of the first portion of the second bracket, a surface of the first offset of the first bracket, and a surface of the first offset of the second bracket. A first fastener connects the first end of the first portion of the first bracket to the second end of the second portion of the second bracket via the first fastener opening and the fourth fastener opening. Similarly, a second fastener connects the first end of the first portion of the second bracket to the second end of the second portion of the first bracket via the second fastener opening and the third fastener opening.

In another aspect, a method of coupling adjacent access control devices is provided comprising the steps of: (a) providing a first access control device at a first site, wherein the first access control device comprises at least one structural member configured to provide structural support for the first access control device; (b) providing a second access control device at the first site, wherein the second access control device comprises at least one structural member configured to provide structural support for the second access control device; (c) placing the second access control device adjacent to the first access control device: (d) providing a gang clamp assembly comprising a first bracket, a second bracket, and at least two fasteners, wherein each of the first bracket and the second bracket further comprises (i) a first portion and a second portion separated by an offset portion, and (ii) a first fastener opening in the first portion and a second fastener opening in the second portion: (e) placing the first bracket on an external surface of the at least one structural member of the first access control device such that the first portion of the first bracket contacts a first portion of the at least one structural member and such that the offset portion of the first bracket contacts a second portion of the at least one structural member; (f) placing the second bracket on an external surface of the at least one structural member of the second access control device such that the first portion of the second bracket contacts a first portion of the at least one structural member and such that the offset portion of the second bracket contacts a second portion of the at least one structural member; (g) connecting the first bracket to the second bracket by inserting a first fastener through the first fastener opening in the first portion of the first bracket and inserting a second fastener through the first fastener opening in the first portion of the second bracket; and (h) tightening the first fastener and the second fastener, wherein tightening the first fastener and the second fastener brings the first bracket and the second bracket into tight contact with the structural members to thereby prevent differential movement between the two adjacent access control devices.

These and other advantages and features, which characterize the invention, are set forth in the claims annexed hereto and forming a further part hereof. However, for a better understanding of the invention, and of the advantages and objectives attained through its use, reference should be made to the figures, and to the accompanying descriptive matter, in which there is described example embodiments of the invention. This summary is merely provided to introduce a selection of concepts that are further described below in the detailed description, and is not intended to identify key or essential features of the claimed subject matter, nor is it intended to be used as an aid in limiting the scope of the claimed subject matter.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 is a perspective view of a two adjacent access control devices at a typical outdoor location on stable ground.

FIG. 2 is a perspective view of the two adjacent access control devices of FIG. 1 situated on unstable ground.

FIG. 3 is a perspective view of a gang clamp assembly according to an embodiment.

FIG. 4 is a side view of the gang clamp assembly of FIG. 3.

FIG. 5 is an end view of the gang clamp assembly of FIG. 3.

FIG. 6 is a top view of two adjacent access control devices on which the gang clamp assembly of FIG. 3 is in use.

FIG. 7 is a front view of two adjacent access control devices on which the gang clamp assembly of FIG. 3 is in use.

FIG. 8 is a right side section view of two adjacent access control devices on which the gang clamp assembly of FIG. 3 is in use, taken at the section line shown in FIG. 7.

FIG. 9 is a view of a detail portion of FIG. 6.

FIG. 10 is a view of a bottom detail portion of FIG. 6.

FIG. 11 is a view of a top detail portion of FIG. 6.

FIG. 12 is a top left perspective cutaway view of a portion of the two access control devices of FIG. 6, showing the gang clamp assembly of FIG. 3 in use.

FIG. 13 is a top front perspective cutaway view of a portion of the two access control devices of FIG. 6, showing the gang clamp assembly of FIG. 3 in use.

### DETAILED DESCRIPTION

The embodiments described herein are directed to a mobile access control device gang clamp assembly, system, and method of use. The following description is provided with reference to the accompanying figures, and is intended only to describe some embodiments in more detail.

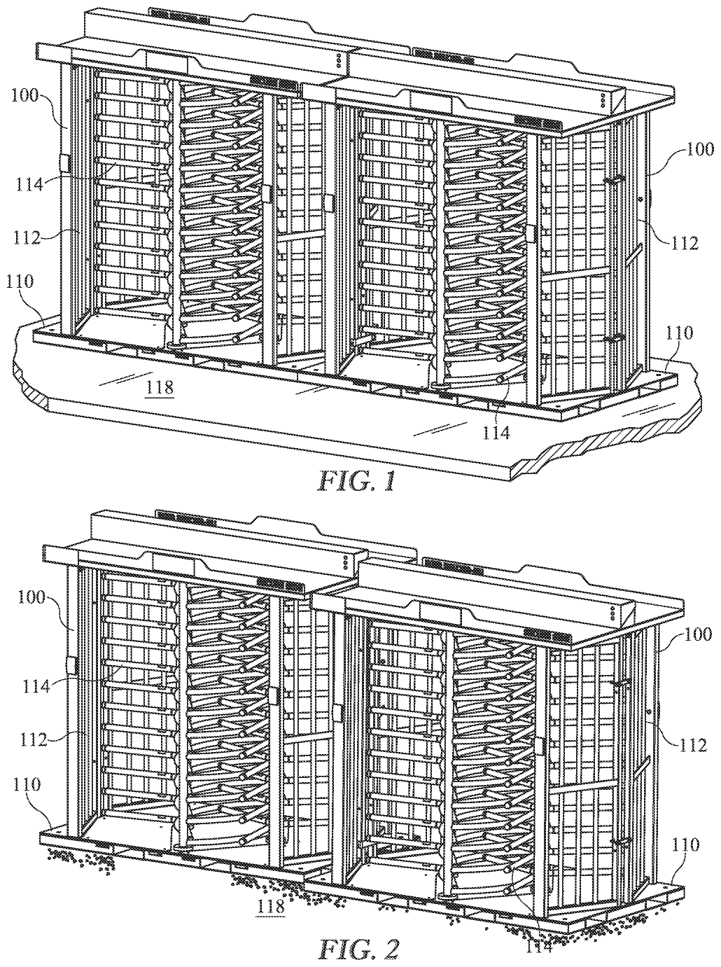

With reference to the figures, various embodiments of a gang clamp assembly 10 is illustrated. FIGS. 1 and 2 depict an embodiment of the gang clamp assembly 10 configured for use on two adjacent mobile access control devices 100. As stated above, many forms and types of access control devices are possible, and many of such devices are placed, either temporarily or permanently, indoors or outdoors. The gang clamp assembly 10 is configured to be used on access control devices that are situated on uneven or unstable ground. This is primarily due to the fact that access control devices that are situated on stable ground (e.g., concrete or asphalt, or indoor hard surfaces inside venues and buildings) generally do not have a tendency to experience differential movement with respect to each other. Therefore, FIGS. 1 and 2 depict a gang clamp assembly 10 in use on two mobile access control devices 100 that are situated at a site—typically, but not necessarily—that is outdoors. FIG. 1 depicts the mobile access control devices on stable ground (e.g., pavement). FIG. 2 depicts the mobile access control devices on unstable ground (e.g., crushed aggregate).

Generally speaking, such mobile access control devices include a base 110 on which one or more perimeter barriers 112 are fixed. One or more movable barriers 114 are also coupled to the base 110 in such a manner that the movable barriers 114 can be activated and deactivated to alternately permit and deny access through the movable barriers 114. In the embodiments shown herein, the mobile access control devices are depicted as mobile full-height turnstiles, wherein the movable barriers 114 are turnstiles rotatably mounted to the base 110. This is not to be deemed as limiting, it is just the embodiment depicted in the figures for ease of reference. Somewhere on each mobile access control device 100 is one or more structural members 116 that provide the structural support for the access control device 100. The term structural support is intended to refer generally to any component of the access control device that is of such a size and strength that it can provide the support necessary to adequately handle the loads experienced by the access control device 100. A structural member a member of such strength that it is not merely a decorative item or fascia item. Obviously the design and type of the access control device will dictate where the structural members are, how many they are, what size they are, where they are located, to what they are connected, and generally how they function. In general, any access control device will have at least one structural member that is vertically-oriented and at least one structural member that is horizontally-oriented, each of which provides the strength and support for the access control device to stand alone and to operate properly. In the embodiments described herein, each access control device 100 has at least one structural member 116.

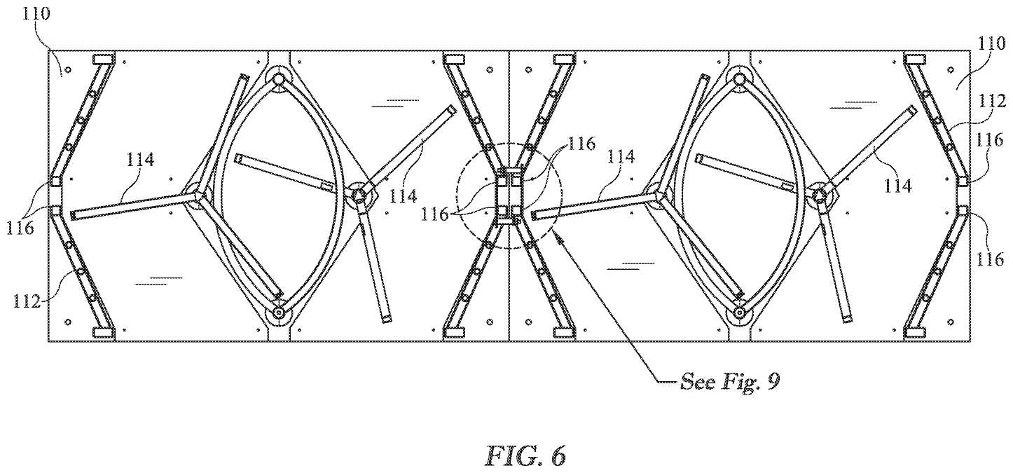

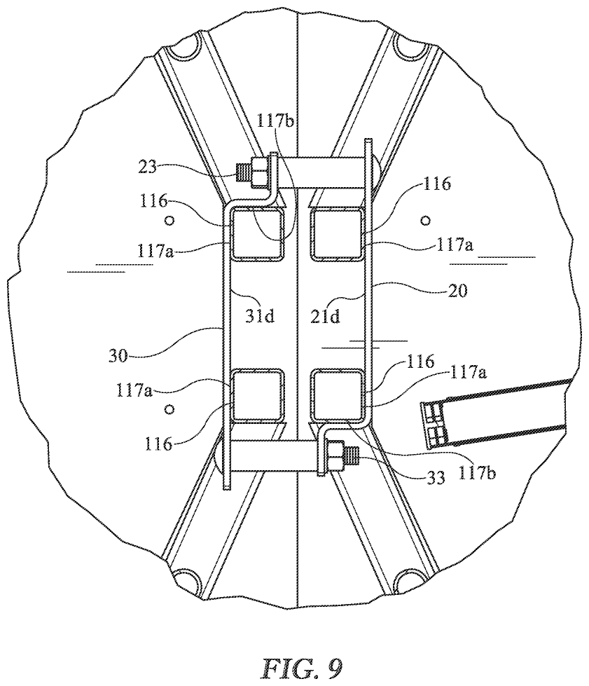

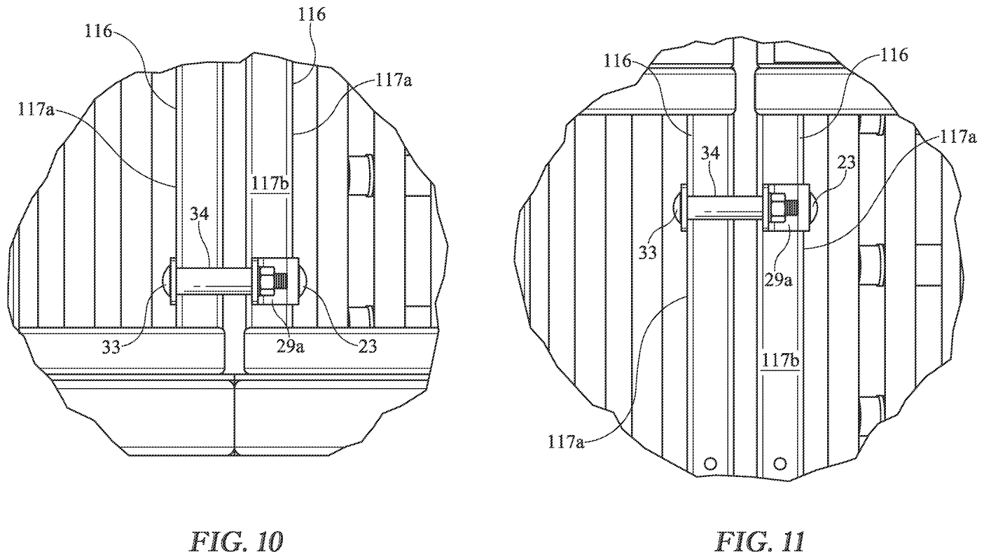

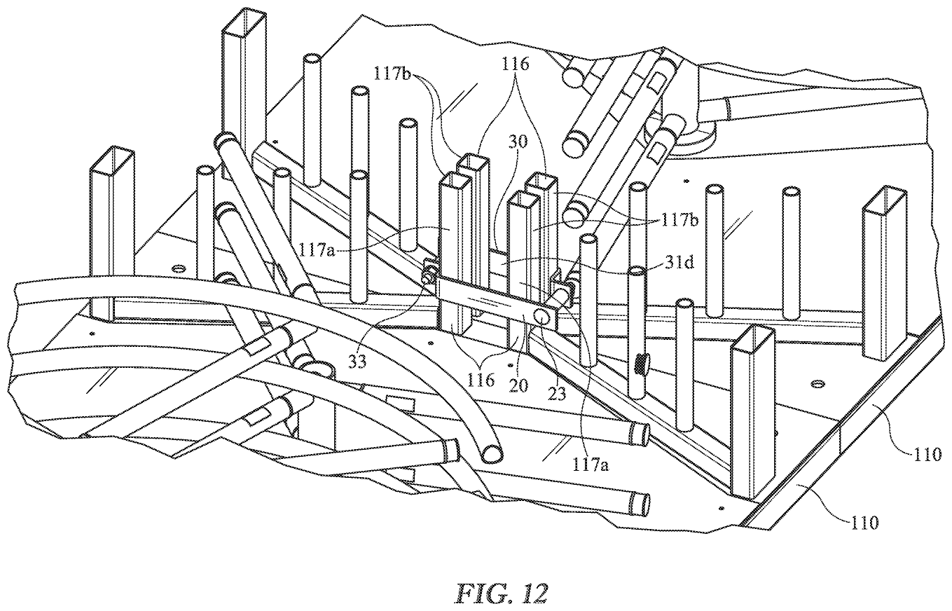

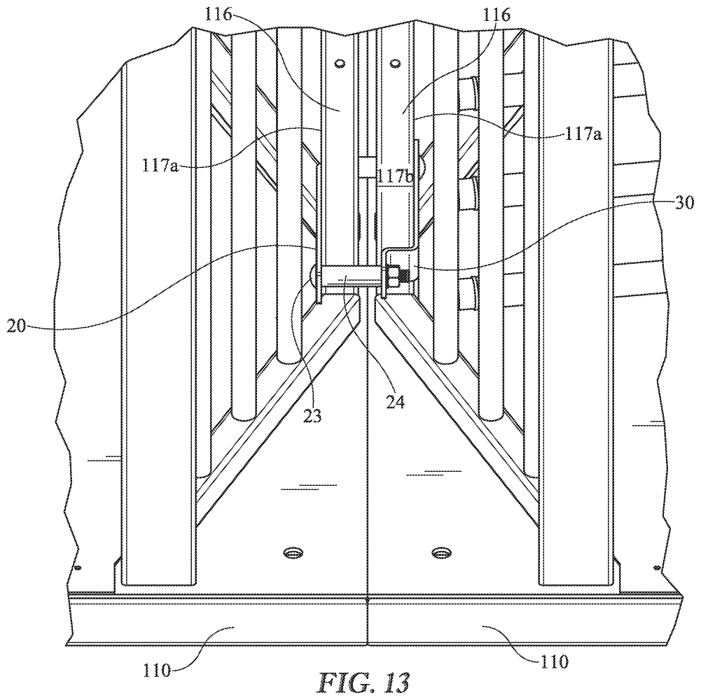

With general reference to FIGS. 6-13, each structural member is located at or near an exterior perimeter of the access control device 100, though this particular placement is not required. In the embodiments shown, the structural member 116 of interest is depicted as a vertically-oriented structural member. However, as stated above, it need not be oriented this way, and indeed many other structural members and configurations are well-known for use in a stand-alone mobile access control device. The structural members 116 of a mobile access control device 100 of the embodiment shown (shown, in non-limiting fashion, in FIG. 12 in the form of two separate members) is situated adjacent to the structural members 116 of another mobile access control device 100 (again, shown in FIG. 12 as two separate members) when the mobile access control devices 100 are situated adjacent each other on a ground surface 118. In such configuration, a gang clamp assembly 10 (discussed below) can be used to secure the mobile access control devices 100 to prevent or minimize relative movement between the mobile access control devices 100. Often, structural members 116 will be made of steel, aluminum, other metals, alloys, and the like and will assume various cross-sectional shapes. Non-limiting examples include channels, square tube sections, rectangular tube sections, I-sections, H-sections, angles, T-sections, tubular sections, as well as other solid and non-solid shapes. One particular shape of the structural members 116 of steel rectangular tube is shown in the figures for case of understanding, it being understood that the size, shape, material, location, and number of structural members 116 are many and the current description is not intended to be limiting. Regardless of the shape of the structural members 116, overall such structural members 116 (whether as a single member per each access control device or, as shown in the figures, as two members per each access control device) will have an external surface 117 against which forces can be applied, as will be discussed below.

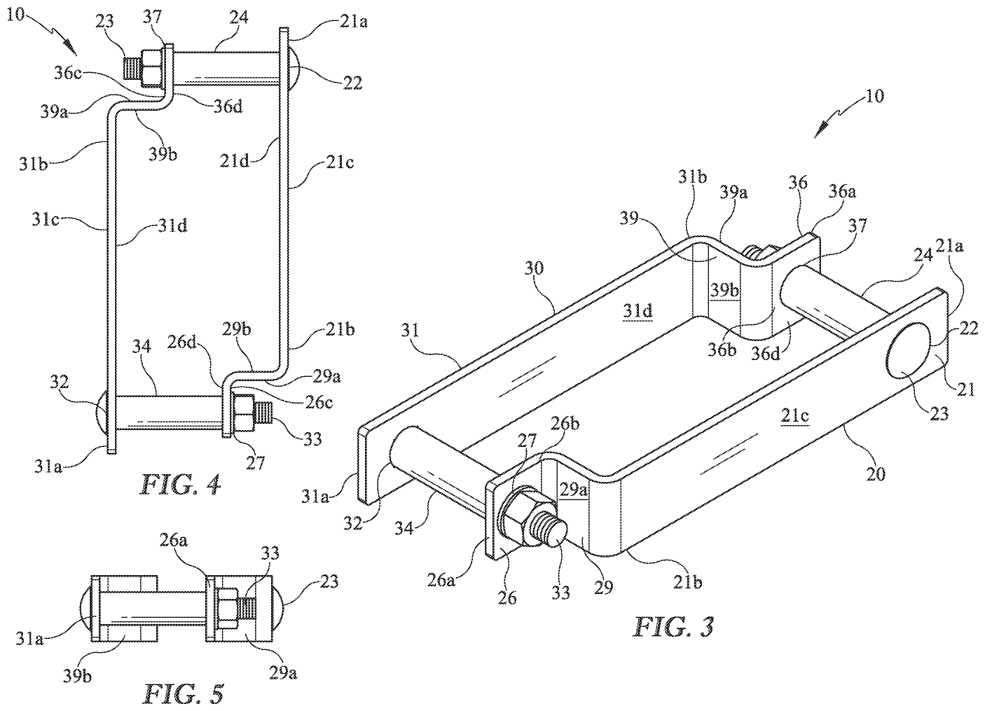

Referring now to FIGS. 3-5, an embodiment of the gang clamp assembly 10 is depicted. The gang clamp assembly 10 in general includes a first bracket 20 and a second bracket 30 that are coupled together with two fasteners, first fastener 23 and second fastener 33. The first bracket 20 and second bracket 30 can take on a variety of sizes, shapes, thickness, and configurations, depending in part on the design of the structural members 116 of the mobile access control devices 100. For case of discussion and understanding of the principles involved. the figures depict one embodiment of the structural members 116 (namely, each structural member 116 of each mobile access control device comprises two separate steel channels) and one embodiment of the first bracket 20 and second bracket 30. In particular, the first bracket 20 and second bracket of the preferred embodiment depicted are made from 0.25 inch flat steel plate that has been bent to provide the first and second offsets 29, 39, respectively. Other materials are, of course, possible, including other types of steel, aluminum, other alloys, stainless steel, painted and non-painted steel, powder coated steel, composites, and the like.

With continuing reference to FIGS. 3-5, the depicted embodiment of the first bracket 20 includes a first leg 21 and a second leg 26 separated by a first offset 29. The first leg 21 can be of many shapes, but in the embodiment shown, is a rectangular body having a thickness and a length and a width. The first leg 21 includes a first end 21a that is a free end, and a second end 21b that terminates at the first offset 29. The first leg 21 also includes an outer surface 21c and an inner surface 21d. Near the first end 21a is a first fastener receiving opening 22. The second leg 26 can be of many shapes, but in the embodiment shown, is a rectangular body having a thickness and a length and a width. The second leg 26 includes a first end 26a that is a free end, and a second end 26b that terminates at the first offset 29. The second leg 26 also includes an outer surface 26c and an inner surface 26d. Near the first end 26a of the second leg 26 is a second fastener receiving opening 27. The first offset 29 can also be of many shapes, but in the embodiment shown, is a rectangular body having a thickness and a length and a width. The first offset 29 joins the second end 21b to the second end 26b of the first leg 21 and second leg 26, respectively. The first offset 29 includes an outer surface 29a and an inner surface 29b.

The second bracket 30 can, but need not be, identical in many or all respects to the first bracket 20. Again, this depends in part on the nature, size, shape, spacing, and configuration of the various structural members 116 that are to be engaged by the gang clamp assembly 10 to retain the mobile access control devices 100. For case of understanding, in the embodiments depicted in the figures, the second bracket 30 is basically a mirror image of the first bracket 20. To that end, the first leg 31 of the second bracket 30 can be of many shapes, but in the embodiment shown, is a rectangular body having a thickness and a length and a width. The first leg 31 includes a first end 31a that is a free end, and a second end 31b that terminates at the second offset 39. The first leg 31 also includes an outer surface 31c and an inner surface 31d. Near the first end 31a is a first fastener receiving opening 32. The second leg 36 can be of many shapes, but in the embodiment shown, is a rectangular body having a thickness and a length and a width. The second leg 36 includes a first end 36a that is a free end, and a second end 36b that terminates at the second offset 39. The second leg 36 also includes an outer surface 36c and an inner surface 36d. Near the first end 36a of the second leg 36 is a second fastener receiving opening 37. The second offset 39 can also be of many shapes, but in the embodiment shown, is a rectangular body having a thickness and a length and a width. The second offset 39 joins the second end 31b to the second end 36b of the first leg 31 and second leg 36, respectively. The second offset 39 includes an outer surface 39a and an inner surface 39b.

In the embodiments shown, the first legs 21, 31 are depicted as being longer than the respective second legs 26, 36 of each respective bracket 20, 30. In this way, the first leg 21, 31 can be called a long leg and the second leg 26, 36 can be called a short leg. But this sizing arrangement is not necessary. Each of the legs could be equal in length; or the reverse sizing could be true; or any other size and/or configuration of shape could be possible for the first legs 21, 31 and second legs 26, 36.

In use, the various surfaces of the brackets 20, 30 and the first and second offsets 29, 39 play an important role in coupling the mobile access control devices 100 together to prevent or minimize relative movement of the mobile access control devices 100. With reference to FIGS. 3, 4, 6, 9, 12 and 13, it can be seen that the gang clamp assembly 10 is configured to engage the structural members 116 of the various mobile access control devices 100. In the embodiment shown in the figures, the gang clamp assembly 10 generally surrounds or envelops the exterior surfaces of the structural members 116. In particular, the inner surfaces 21d, 31d of the first legs 21, 31, respectively, are configured to be in contact with the external surfaces 117a, 117b of the various structural members 116 when the assembly is completed. This means that the length of the first and second fasteners 23, 33, are configured such that the inner surface 21d of the first bracket 20 can be in tight physical contact with the outer surface 117a of the structural members 116 of one mobile access control device 100 while the inner surface 31d of the second bracket 30 can be in tight physical contact with the outer surface 117a of the structural members 116 of a second mobile access control device 100. In addition, the inner surfaces 29b, 39b of the first offset 29 and second offset 39, respectively, are configured to engage different external surfaces 117 (namely, 117b) of the structural members 116. This occurs primarily due to some dimensional relationships among the various components.

With reference to FIGS. 6 and 9-13, it can be seen that, when the gang clamp assembly 10 assembled, the inner surface 21d of the first leg 21 of the first bracket 20 contacts a first external surface 117a of one structural member 116 of one mobile access control device. In the embodiment shown, structural member 116 comprises two separate components, so the inner surface 21d of the first leg 21 of the first bracket 20 contacts both these surfaces. Similarly, the inner surface 29b of the first offset 29 of the first bracket 20 contacts a second external surface 117b of one structural member 116 of one mobile access control device. Also, it can be seen that the inner surface 31d of the first leg 31 of the second bracket 30 contacts a first external surface 117a of one structural member 116 of a second, different (adjacent) mobile access control device. In the embodiment shown, structural member 116 comprises two separate components, so the inner surface 31d of the first leg 31 of the second bracket 30 contacts both these surfaces. Similarly, the inner surface 39b of the second offset 39 of the second bracket 30 contacts a second external surface 117b of one structural member 116 of the second mobile access control device.

To join the first bracket 20 to the second bracket 30 (thus joining the two mobile access control units 100), fasteners are used. In particular, a first fastener 23 is inserted through the first fastener receiving opening 22 of the first leg 21 of the first bracket 20 and through the second fastener receiving opening 37 of the second leg 36 of the second bracket 30. Similarly, a second fastener 33 is inserted through the first fastener receiving opening 32 of the first leg 31 of the second bracket 30 and through the second fastener receiving opening 27 of the second leg 26 of the first bracket 20. If desired, optional spacers 24 can be used between the first bracket 20 and second bracket 30, as shown in the figures. A carriage bolt with accompanying washer and nut are depicted in the figures as the first fastener 23 and second fastener 33 (specifically, a grade 5 zinc plated ⅝″-11×5″ carriage bolt, nut, and washer), but the fasteners are not limited to this structure. Any commonly known fastener of suitable strength and material properties (e.g., other types of bolts; pins with holes; cam locks; and the like) capable of use in holding such large structures together are possible. And, of course, the diameter and length of each fastener simply depends on the sizes needed for the particular application.

With fasteners inserted, the first bracket 20 and second bracket 30 can be brought closer together by tightening the first and second fasteners 23, 33, respectively. Tightening the fasteners 23, 33 causes the inner surface 21d to more forcefully bear against the first external surface 117a of the structural member 116 of one mobile access control device 100 and causes the inner surface 31d to more forcefully bear against the first external surface 117a of the structural member 116 of a second (adjacent) mobile access control device 100. Similarly, each inner surface 29b. 39b of the first and second offsets 29, 39, respectively, bears against respective second external surfaces 117b of the structural member 116. Thus, when assembled, the distance between the inner surface 29b of the first offset 29 and the inner surface 39b of the second offset 39 is approximately the same as, and preferably slightly larger than, the distance of the second external surface 117b of the structural member 116 of one mobile access control device 100 to the second external surface 117b of the structural member 116 of the second (adjacent) mobile access control device 100. In the embodiment shown in the figures, the inner surface 29a of the first offset 29 bears against a second external surface 117b of a structural member 116 of one mobile access control device 100, and the inner surface 39a of the second offset 39 bears against a second external surface 117b of a structural member 116 of a second (adjacent) mobile access control device 100. Thus, when the first and second fasteners 23, 33 are tightened, the gang clamp assembly 10 holds two adjacent mobile access control devices 100 together and prevents one of the mobile access control devices 100 from moving relative.

With continuing reference to the figures, various methods of coupling adjacent access control devices 100 using the gang clamp assembly 10 are possible. First, a mobile access control device 100 is brought to a first site. The site is typically a construction site or similar location, where the ground on which the base 110 of the mobile access control device 100 is to be placed is something that is not stable or level. Examples of such ground include, but are not limited to, gravel, dirt, mud, crushed asphalt, crushed concrete, other granular material, and the like. The mobile access control device 100 comprises at least one structural member 116 configured to provide structural support for the mobile access control device 100. A second mobile access control device 100 is also brought to the first site, and it too has at least one structural member 116 configured to provide structural support for the second access control device 100.

Next, the second mobile access control device 100 is placed adjacent to the first access control device 100. This can be done in a variety of ways, including by crane, skidsteer, loader, helicopter, and other forms of machinery lifting and placement apparatus.

Next, a gang clamp assembly 10 is provided having a first bracket 20, a second bracket 30, and at least two fasteners 23, 33. The first bracket 20 is placed on an external surface 117 of at least one structural member 116 of the first mobile access control device 100 such that the inner surface 21d of the first leg 21 of the first bracket 20 contacts a first external surface 117a of the at least one structural member 116 and such that the inner surface 29b of the first offset 29 of the first bracket 20 contacts a second external surface 117b of the at least one structural member 116.

A second bracket 30 is placed on a first external surface 117a of at least one structural member 1116 of the second access control device 100 such that the inner surface 31d of the first leg 31 of the second bracket 30 contacts a first external surface 117a of the at least one structural member 116 and such that the inner surface 39b of the second offset 39 of the second bracket 20 contacts a second external surface 117b of the at least one structural member 116.

The first bracket 20 and second bracket 30 are then connected by inserting a first fastener 23 through the first fastener receiving opening 22 in the first leg 21 of the first bracket 20, and inserting a second fastener 33 through the first fastener opening 32 in the first leg 31 of the second bracket 30. If desired, a sleeve 24 can be used between the first bracket 20 and second bracket 30. Suitable fastener components (in the embodiment shown, a washer and a nut) are coupled to the opposite end of the first and second fasteners 23, 33, respectively.

The first fastener 23 and second fastener 33 are then tightened, which brings the first bracket 20 and the second bracket 30 into tight contact with the structural members 116. In particular, this tightening forces the inner surfaces 21d. 31d of the first legs 21, 31 of the first and second brackets 20, 30, respectively, into contacting engagement with first external surfaces 117a of the structural members 116. This contacting engagement prevents differential movement between the two adjacent mobile access control devices 100 in, at least, a direction normal to the plane of the inner surfaces 21d. 31d. Also, due to the tight frictional engagement between the inner surfaces 21d, 31d and the first external surfaces 117a, this engagement also can minimize differential movement between the two adjacent mobile access control devices 100 in a direction parallel to the plane of the inner surfaces 21d. 31d (namely, a vertical direction). If additional vertical relative movement is desired to be minimized or prevented, it is possible to add additional fasteners that penetrate the brackets (first bracket 20 or second bracket 30) and the structural members 116. Also, the inner surfaces 29b. 39b of the first and second offsets 29, 39, respectively, are placed into contacting engagement with second external surfaces 117b of the structural members 116. This engagement prevents or minimizes differential lateral movement between the two adjacent mobile access control devices 100 in a direction parallel to the plane of the inner surfaces 21d. 31d (namely, a horizontal direction parallel to the plane of the inner surfaces 21d. 31d). In this manner, the gang clamp assembly 10 can securely retain adjacent mobile access control devices 10 and minimize or eliminate differential movements therebetween.

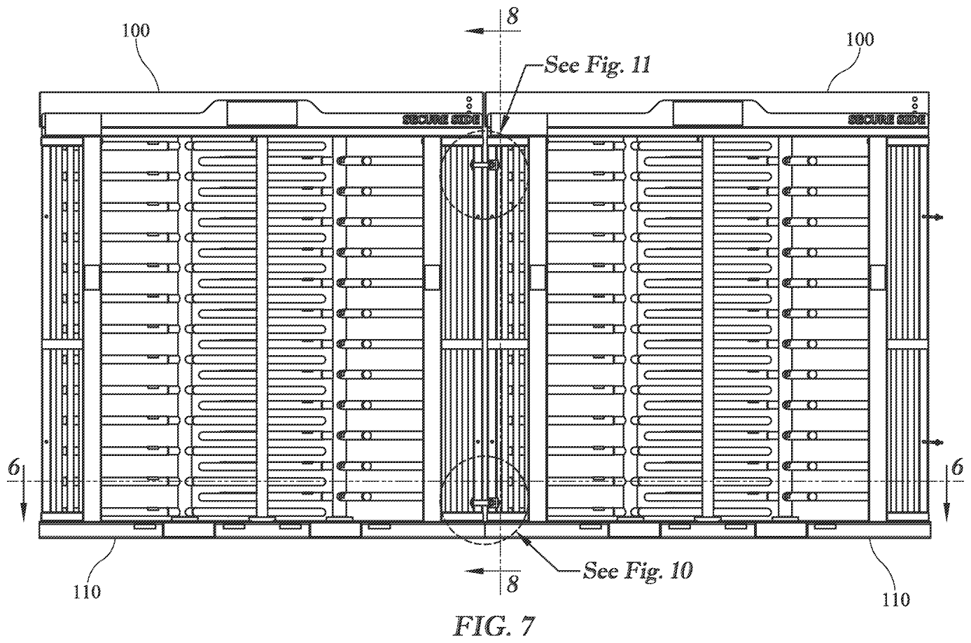

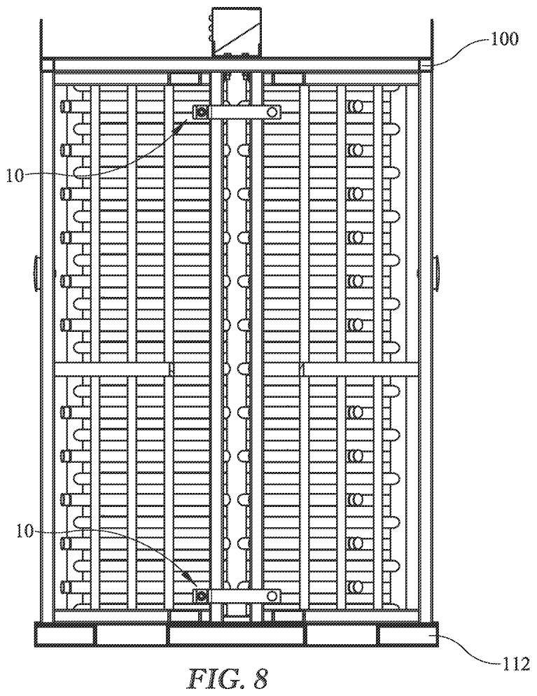

As shown in the depicted embodiment, it is common for multiple gang clamp assemblies 10 to be utilized to provide proper movement restraint. FIGS. 7 and 8 depict two such gang clamp assemblies 10 used on two adjacent mobile access control devices 100. More or fewer gang clamp assemblies 10 can be used, depending on the needs of the user. Additional embodiments can also include various theft control and/or detection systems and methods. For example, one or more switches (e.g., magnetic reed switches) can be incorporated into the first bracket 20 and/or second bracket 30 such that a signal is produced when contact between the brackets 20, 30 and the structural members 116 is lost. Any number and type of switches could be employed as would be understood to a person of ordinary skill in the art. Simpler forms of theft deterrent/control are also possible, for example adding one or more physical locks to the system. As but one example, additional holes could be drilled through the first bracket 20 and/or second bracket 30 and the structural members 116 to receive one or more of various types of physical locks (e.g., padlock). Alternatively, in lieu of drilling additional holes, the first bracket 20 and/or second bracket 30 could be modified to receive one end of a tether (e.g., chain, cable, and the like), while the other end of the tether can be looped around the structural member 116 and locked to either the first bracket 20 or second bracket 30, or to the first end of the tether itself. An example modification could include an extra tab welded to one of the brackets 20, 30 to which a tether can be coupled.

While several embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

It is to be understood that the embodiments are not limited in its application to the details of construction and the arrangement of components set forth in the description or illustrated in the drawings. The invention is capable of other embodiments and of being practiced or of being carried out in various ways. Unless limited otherwise, the terms “connected,” “coupled,” “in communication with,” and “mounted,” and variations thereof herein are used broadly and encompass direct and indirect connections, couplings, and mountings. In addition, the terms “connected” and “coupled” and variations thereof are not restricted to physical or mechanical connections or couplings.

The foregoing description of several embodiments of the invention has been presented for purposes of illustration. It is not intended to be exhaustive or to limit the invention to the precise structure, steps, and/or forms disclosed, and obviously many modifications and variations are possible in light of the above teaching.

1. A gang clamp assembly for access control devices comprising:
a first bracket having a first leg and a second leg separated from said first leg by a first offset, said first leg having an outer surface and an inner surface and said second leg having an outer surface and an inner surface;
a second bracket having a first leg and a second leg separated from said first leg by a second offset, said first leg having an outer surface and an inner surface and said second leg having an outer surface and an inner surface;
said first bracket having a first fastener opening in said first leg of said first bracket and a second fastener opening in said second leg of said first bracket;
said second bracket having a first fastener opening in said first leg of said second bracket and a second fastener opening in said second leg of said second bracket;
wherein when assembled for use, a first fastener extends through said first fastener opening of said first leg of said first bracket and through said second fastener opening of said second leg of said second bracket; and a second fastener extends through said first fastener opening of said first leg of said second bracket and through said second fastener opening of said second leg of said first bracket.

2. The gang clamp assembly for access control devices of claim 1, wherein said inner surface of said first leg faces said inner surface of said second leg.

3. The gang clamp assembly for access control devices of claim 2, wherein said first offset and said second offset each have an inner surface and an outer surface, and said inner surfaces face each other.

4. The gang clamp assembly for access control devices of claim 1, wherein when assembled for use, said first leg of said first bracket is parallel to said first leg of said second bracket.

5. The gang clamp assembly for access control devices of claim 1, wherein when assembled for use, said second leg of said first bracket is parallel to said second leg of said second bracket.

6. The gang clamp assembly for access control devices of claim 1, wherein said assembly encircles structural members of a first access control device and a second access control device.

7. The gang clamp assembly for access control devices of claim 6, wherein the structural members of the first access control device and the second access control device are in physical contact with the inner surfaces of said first legs of said first bracket and said second bracket and the inner surfaces of said first offset and said second offset.

8. The gang clamp assembly for access control devices of claim 1, wherein said first fastener is a bolt and nut wherein said bolt bears against said outer surface of said first leg of said first bracket and wherein said nut bears against said outer surface of said second leg of said second bracket.

9. The gang clamp assembly for access control devices of claim 1, wherein said second fastener is a bolt and nut wherein said bolt bears against said outer surface of said first leg of said second bracket and wherein said nut bears against said outer surface of said second leg of said first bracket.

10. A gang clamp assembly for securing adjacent access control devices comprising:
a first bracket having a first portion with a first fastener opening at a first end of said first portion, and a second portion with a second fastener opening at a second end of said second portion, said first bracket having a first offset separating said first portion from said second portion, said first portion being parallel to said second portion and;
a second bracket having a first portion with a third fastener opening at a first end of said first portion, and a second portion with a fourth fastener opening at a second end of said second portion, said second bracket having a first offset separating said first portion from said second portion, said first portion being parallel to said second portion;
wherein said first bracket and said second bracket are configured to envelop one or more structural members of the two adjacent access control devices such that said one or more structural members engage a surface of said first portion of said first bracket, a surface of said first portion of said second bracket, a surface of said first offset of said first bracket, and a surface of said first offset of said second bracket;
wherein a first fastener connects said first end of said first portion of said first bracket to said second end of said second portion of said second bracket via said first fastener opening and said fourth fastener opening; and
wherein a second fastener connects said first end of said first portion of said second bracket to said second end of said second portion of said first bracket via said second fastener opening and said third fastener opening.

11. The gang clamp assembly of claim 10, wherein said first bracket is a bent-plate wherein said first offset is approximately perpendicular to said first portion and said second portion of said first bracket.

12. The gang clamp assembly of claim 10, wherein said second bracket is a bent-plate wherein said second offset is approximately perpendicular to said first portion and said second portion of said second bracket.

13. The gang clamp assembly of claim 10, wherein a length of said first portion of said first bracket to said first offset corresponds to a first dimension of said structural members.

14. The gang clamp assembly of claim 13, wherein a length of said first portion of said second bracket to said second offset corresponds to a second dimension of said structural members.

15. The gang clamp assembly of claim 14, wherein said first dimension and said second dimension are equal.

16. A method of coupling adjacent access control devices comprising the steps of:
providing a first access control device at a first site, wherein the first access control device comprises at least one structural member configured to provide structural support for the first access control device;
providing a second access control device at the first site, wherein the second access control device comprises at least one structural member configured to provide structural support for the second access control device;
placing the second access control device adjacent to the first access control device;
providing a gang clamp assembly comprising a first bracket, a second bracket, and at least two fasteners, wherein each of said first bracket and said second bracket further comprises (i) a first portion and a second portion separated by an offset portion, and (ii) a first fastener opening in said first portion and a second fastener opening in said second portion;
placing said first bracket on an external surface of said at least one structural member of the first access control device such that said first portion of said first bracket contacts a first portion of the at least one structural member and such that said offset portion of said first bracket contacts a second portion of the at least one structural member;
placing said second bracket on an external surface of said at least one structural member of the second access control device such that said first portion of said second bracket contacts a first portion of the at least one structural member and such that said offset portion of said second bracket contacts a second portion of the at least one structural member;
connecting said first bracket to said second bracket by inserting a first fastener through said first fastener opening in said first portion of said first bracket and inserting a second fastener through said first fastener opening in said first portion of said second bracket; and
tightening said first fastener and said second fastener, wherein tightening said first fastener and said second fastener brings said first bracket and said second bracket into tight contact with said structural members to thereby prevent differential movement between said two adjacent access control devices.

17. The method of coupling adjacent access control devices of claim 16, wherein said at least one structural member is vertically-oriented.

18. The method of coupling adjacent access control devices of claim 17, wherein said first fastener further includes a sleeve.

19. The method of coupling adjacent access control devices of claim 17, wherein said offset portion of said first and said second brackets is disposed approximately perpendicularly to said first portion of said first and said second brackets.

20. The method of coupling adjacent access control devices of claim 19, wherein a distance from an interior surface of said first portion of said first bracket to an interior surface of said first portion of said second bracket coincides with a first external surface dimension of said at least one structural member of said first and said second access control devices when said first and said second fasteners are fully tightened.

21. The method of coupling adjacent access control devices of claim 20, wherein a distance from an interior surface of said offset portion of said first bracket to an interior surface of said offset portion of said second bracket coincides with a second external surface dimension of said at least one structural member of said first and said second access control devices when said first and said second fasteners are fully tightened.
